(19) United States
(12) Patent Application Publication
(10) Pub. No.: US 2008/0178109 A1
(43) Pub. Date: Jul. 24, 2008

(54) Virtual dynamic pattern rendering system that changes its display status according to external information

(76) Inventor: Chin-Chuan Liang, Hsinchu City (TW)

Correspondence Address: Joe McKinney Muncy, PO Box 1364, Fairfax, VA, 22038-1364, US

(21) Appl. No.: 11/657,101

(22) Filed: Jan. 24, 2007

(51) Int. Cl. G06F 3/048

(52) U.S. Cl. 715/771

(57) ABSTRACT

This specification discloses a virtual dynamic pattern system that changes its display status according to the external information. A host is built in with a virtual dynamic pattern rendering procedure. The host controls a display to show a dynamic pattern. The rendering procedure sets the internal/external parameters of an initial pattern, corresponding to the internal/external features of the pattern. The host obtains the external parameters using an external information extracting unit for changing the features. In addition to allowing the user to change the internal dynamic parameters via the input device of the host for changing the dynamic pattern display images, the host further automatically obtains external information and changes the external dynamic parameters. The dynamic pattern thus changes according to the external information, rendering the variety of images.

### BACKGROUND OF THE INVENTION

1. Field of the Invention

The invention relates to a virtual dynamic pattern rendering system and, in particular, to a virtual dynamic pattern rendering system that changes its display status according to external information for achieving the versatility in virtual dynamic pattern displays and patternizes unspecified external information.

2. Description of Related Art

Most industries and technologies have been computerized. Thanks to the advances in the semiconductor industry, our daily utilities such as computers, toys, cameras, and televisions are largely digitalized.

Take toys as an example. After incorporating displays, lights, and speakers, toys start to become vivid. Moreover, sometimes game software is installed on the circuit board inside the toys. Through buttons, switches, or sensors, players can enjoy the fun of interactions with the toys. An example is the previously popular electronic pet machines. With the game buttons, the players can have interactions with the pet established by the software and shown on the display. The software is coded with life and growth factors of specific pets. By operating specific function buttons, the player can determine the growing conditions of the little pet. The growing conditions are then displayed on the display for the player to learn how the pet changes, thereby achieving interactions.

Whether it is an electronic pet machine or computer game, the game rules are specified by the manufacturer and installed in the machine. The functions of buttons or switches are fixed for the player to use or follow. Since such machines or toys are usually built in with only one set of game content and display images, player often get bored after playing them for a while.

### SUMMARY OF THE INVENTION

An objective of the invention is to change fixed game rules and the virtual dynamic patterns with fixed internal parameters, so that the produced virtual dynamic patterns can change according to not only the internal parameters set by the machine or system but also specific external information. Therefore, the player or user can be freed from monotonic interactions with the machine or system.

To achieve the above objective, the disclosed virtual dynamic pattern rendering system includes a host and a display electrically coupled to the host. The host is built in with a method for rendering virtual dynamic patterns that includes the steps of:

establishing an initial virtual pattern;

determining feature parameters of the dynamic pattern;

associating internal dynamic patterns with the corresponding features of the pattern, wherein each of the internal dynamic parameters is determined by the user;

associating external dynamic patterns with the corresponding features of the pattern, wherein each of the external dynamic parameters is determined by an independent external signal (e.g., a wireless communication signal, Internet signal, or electronic signal generated by the operating system of another host) that enters the host;

displaying the initial pattern on the display;

receiving the internal and external dynamic parameters, determining whether any of them is changed and changing the corresponding feature parameters if some of them is changed; and

changing the initial dynamic pattern according to the changes in the feature parameters, so that the changed images reflect the variations in the internal or external parameters.

The purpose of the invention is to let the virtual dynamic patterns shown on the display respond not only to the internal dynamic parameters, but also to external information that enters the host. That is, the user changes only the internal dynamic parameters via the corresponding input devices (e.g., buttons, switches, keyboard, mouse), but cannot modify the external dynamic parameters of the invention. Consequently, the virtual dynamic patterns displayed by the host change according to both the information generated internally by the host and the external information that enters the host. As a result, the user cannot fully control how the host generates the virtual dynamic patterns. Moreover, the external dynamic parameters can be set as the parameters that reflect the interactions between the user and environment. From the variation of the virtual patterns, the user can learn how he or she interacts with the environment. Therefore, the disclosed virtual dynamic pattern rendering system also has the effect of patternizing the external information.

### BRIEF DESCRIPTION OF THE DRAWINGS

FIG. 1 is a functional block diagram of the disclosed system in accordance with the present invention;

FIG. 2 is a schematic view of the screen on a mobile phone with the invention in accordance with the present invention;

FIGS. 3A and 3B show the relationship between various parameters in FIG. 2 and the pattern features in accordance with the present invention;

FIG. 4 shows the relationship between the external dynamic parameters in FIG. 2 and the internal features of the pattern in accordance with the present invention;

FIG. 5 is a schematic view of the screen on a computer with the invention; and

FIG. 6 shows the relationship between the external dynamic parameters in FIG. 5 and the internal features of the pattern.

### DETAILED DESCRIPTION OF THE PREFERRED EMBODIMENT

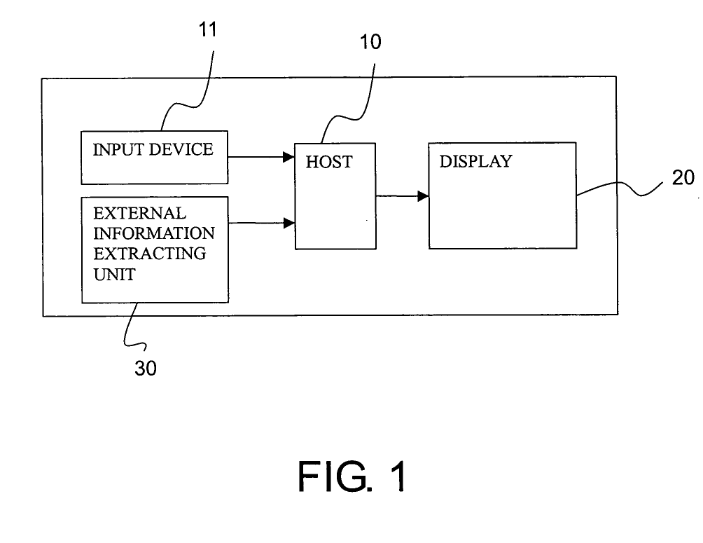

FIG. 1 shows the block diagram of the disclosed virtual dynamic pattern rendering system. The system includes a host 10 with input devices and a display 20 coupled to the host 10. The host 10 has an input device 11 and an external information extracting unit 30. The input device 11 can be a keyboard, mouse, or some other input apparatus. The external information extracting unit 30 enters the information not generated by the input device to the host 10. The host then executes the following steps:

The host is built in with an initial dynamic pattern containing initial parameters, time parameter, internal dynamic parameters, and external dynamic parameters. The host determines the features of the dynamic pattern, where the features can be external and internal. The internal dynamic parameters, determined by the user, are associated with the corresponding features of the pattern. The external dynamic parameters are associated with the corresponding features of the pattern. In particular, each of the external dynamic parameters is determined by an independent external signal (e.g., a wireless communication signal, Internet signal or electronic signal generated by the operating system of another host) that enters the host. Moreover, different external dynamic parameters can be given different weights.

The host then shows the initial pattern on the display. Afterwards, the host receives internal and external dynamic parameters and determines whether any of them is changed. If some of them are changed, the corresponding feature parameters are changed as well. The initial dynamic pattern is modified according to the feature parameters, so that the modified image reflects the variations in the internal or external dynamic parameters.

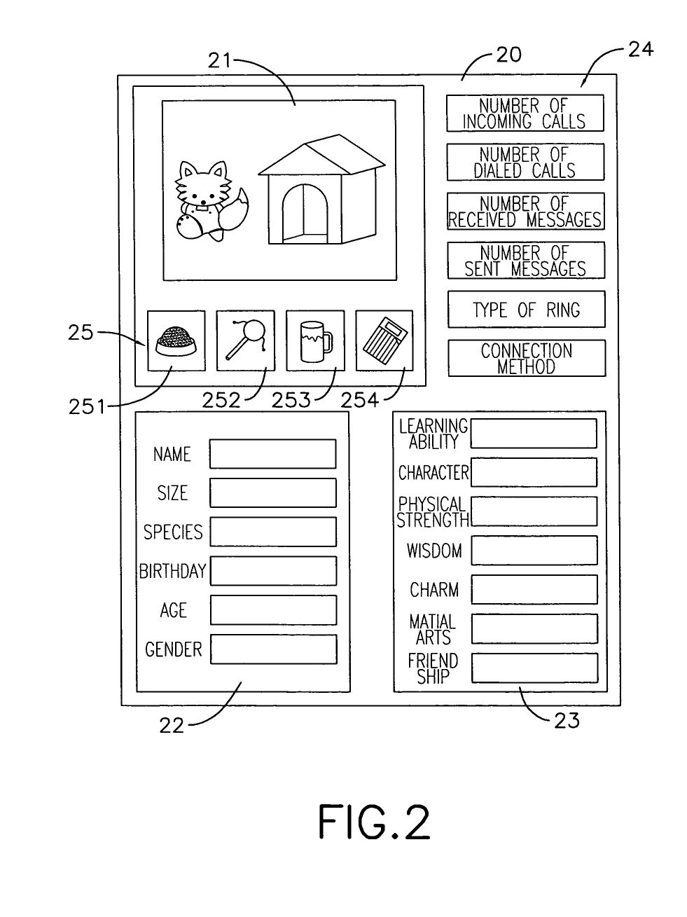

With further reference to FIG. 2, an actual application is used to further explain the main technical features of the disclosed virtual dynamic pattern rendering system. In this embodiment, the invention is applied to a mobile phone. The mobile phone has a display 20 and a host 10 that controls the display 20. The external information extracting unit is the circuit unit that communicates signals with a base station. The mobile phone is built in with the above-mentioned procedure for generating virtual dynamic patterns. An electronic pet is thus created for the user to raise.

According to this embodiment, the display 20 has a pattern display area 21, an external feature area 22, an internal feature area 23, an external dynamic parameter area 24, and an internal dynamic parameter area 25. The dynamic parameter area 25 has a food button 251, a play button 252, a drink button 253, and a sleep button 254. The external features of the electronic pet include the name, size, species, birthday, age, and gender. The internal features of the electronic pet include learning ability, character, physical strength, wisdom, charm, martial arts, and friendship. Since it is applied to a mobile phone that can communicate to others, the external dynamic parameters can be determined by wireless communication signals. Such signals include the number of incoming calls, the number of outgoing calls, the number of received messages, the number of sent messages, type of ring, and connection method. Moreover, the external dynamic parameters can be associated with different weights so that when the host receives an external dynamic parameter with a higher weight, the associated internal and external features of the pattern become more apparent.

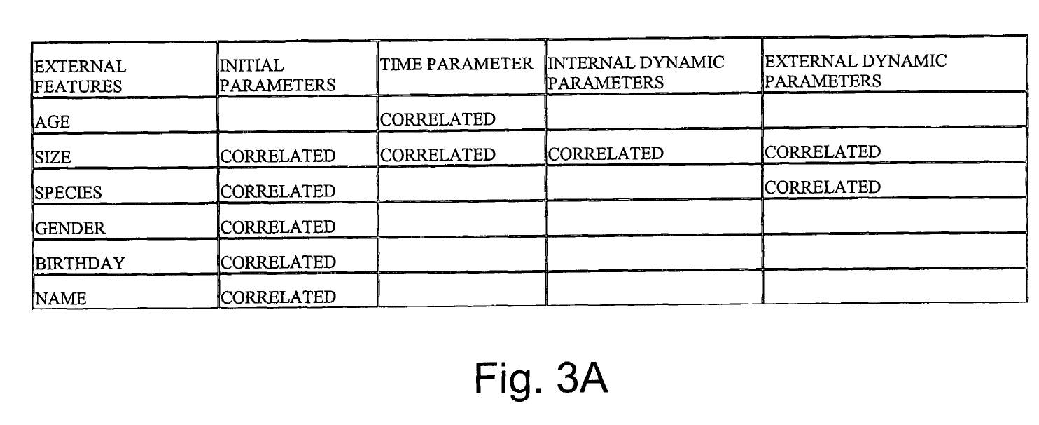

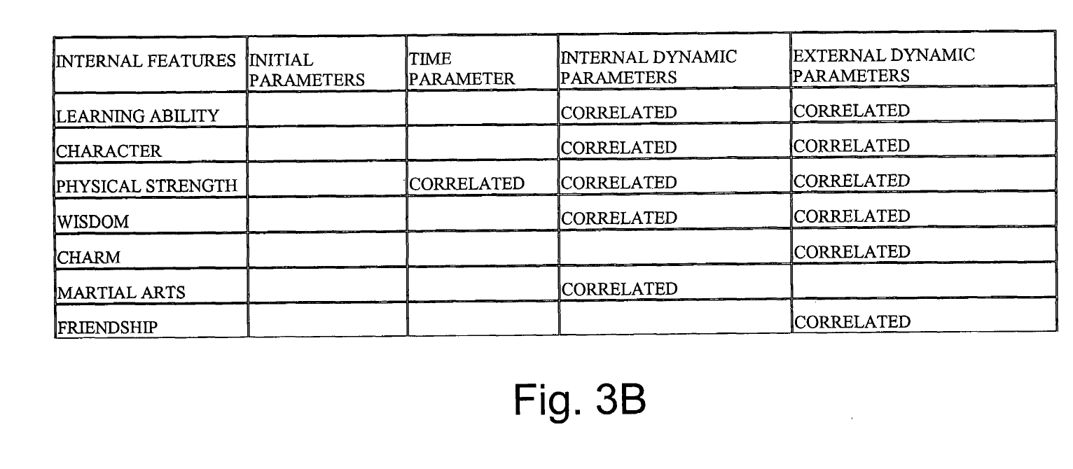

With reference to FIG. 2 and FIGS. 3A and 3B show the relationship between the initial parameters, time parameter, internal dynamic parameters, and external dynamic parameters and the external features. That is, the initial parameters determine the size, species, birthday, and name of the initial dynamic pattern. The time parameter changes the age and size features. The internal dynamic parameters are related to the size. The external dynamic parameters are related to the size and species. Therefore, the user can change the internal dynamic parameters using the input devices of the food button 251, play button 252, drink button 253, and sleep button 254, thereby changing the size of the pet. Besides, another variable factor of the size can come from the external dynamic parameters. Therefore, the pet size also varies with the number of incoming calls, the number of dialed calls. This extends the user's interest in raising the electronic pet.

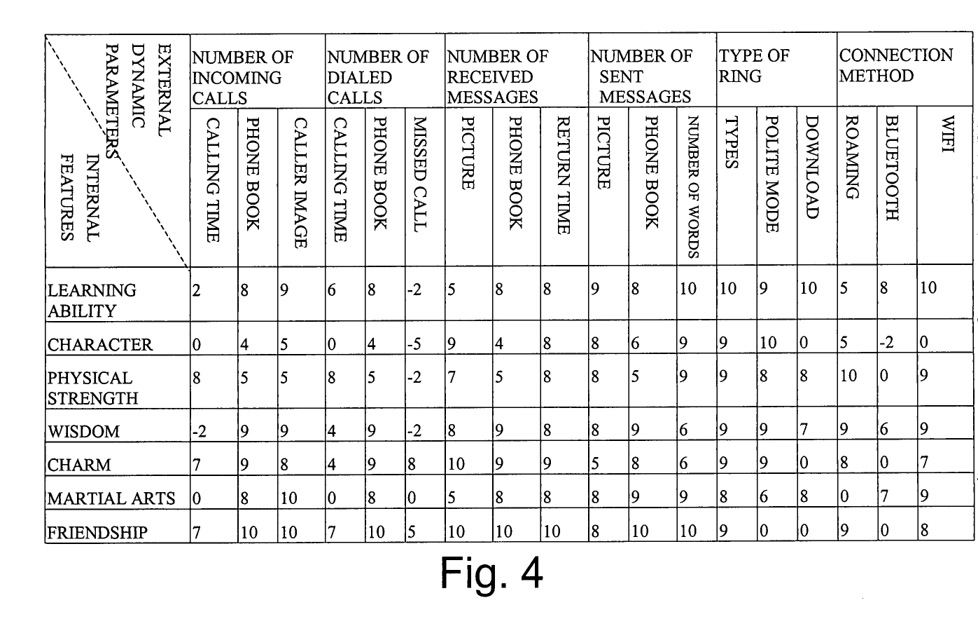

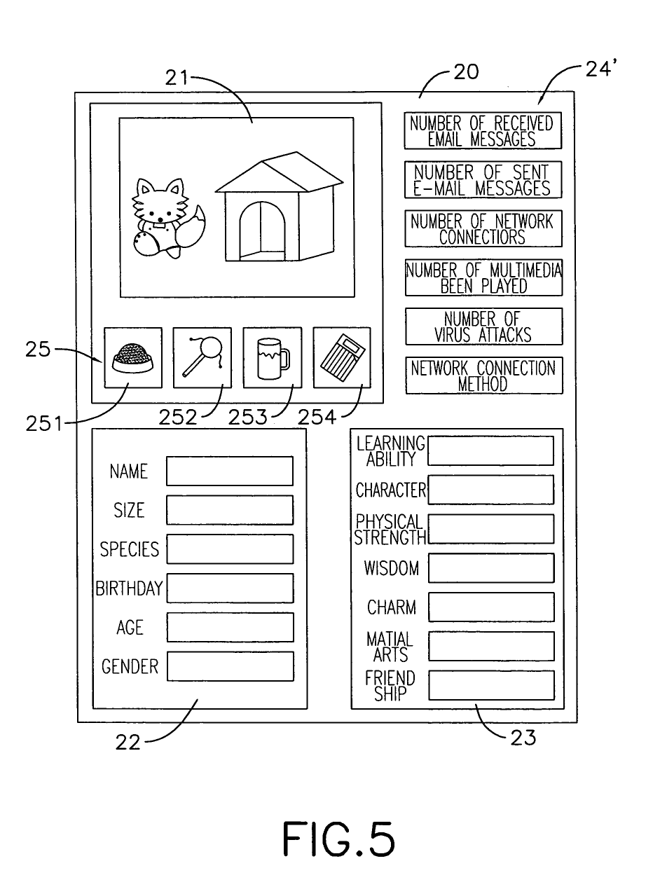

Moreover, the invention extracts the external communication status of the host to affect how the electronic pet is raised (change in the external features). Therefore, the electronic pet can be further provided with internal features, so that it feels more like real. FIGS. 4 and 5 show the relationship between the external dynamic parameters in the external dynamic parameter area 24′ with the internal features of the pet.

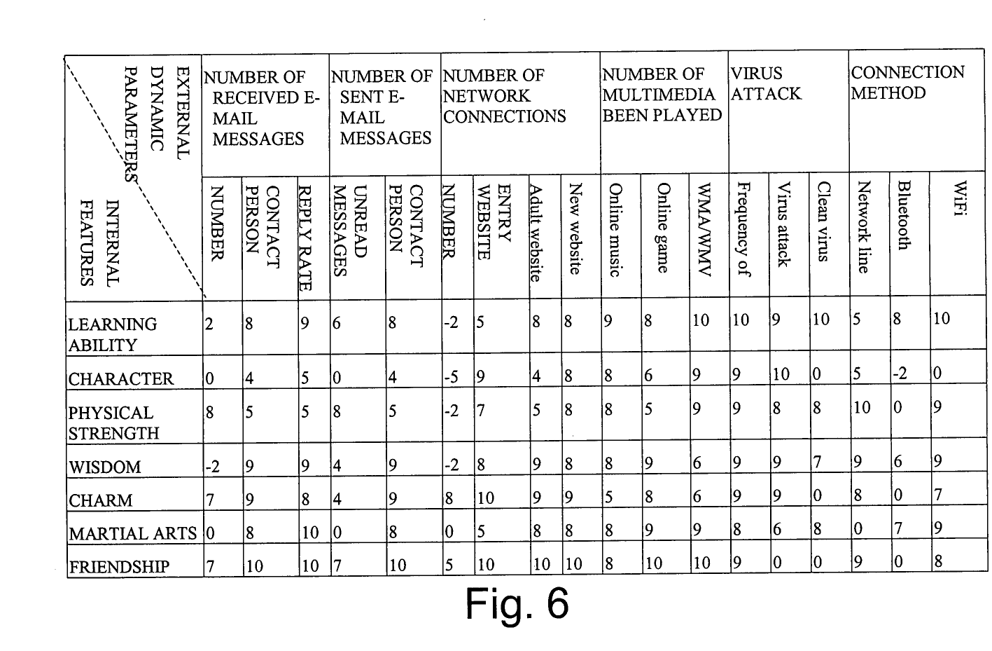

Likewise, the invention can be used in a computer that can connect to the Internet. The computer includes a host and a display. The network card, modem, or optical disk drive of the host can be considered as the external information extracting unit for obtaining the external dynamic parameters. As shown in FIG. 5, the external dynamic parameters are the network signals that enter the computer host from the Internet and may include the numbers of receiving/sent E-mail messages, the number of Internet connections, the number of multimedia been played, the number of virus attacks, and the network connection method. FIG. 6 shows the relation between the external dynamic parameters and the internal features in this embodiment. According to the drawing, the electronic pet presented by the invention can reflect the information actually exchanged between the user and the environment. It is thus more fun for the user to raise the electronic pet.

In addition to the above-mentioned two applications for individuals, the invention can be used in data management in companies or organizations. For example, there may be quality control for subway stations. In addition to people working at the stations, the number of travelers is also another important reference. Applying the invention to the subway station is to build in their management computers with the procedure of generating virtual dynamic patterns. In particular, one of the external dynamic parameters is set as the number of travelers every day or week. Therefore, the external dynamic parameter in this embodiment is determined by the electronic signal (representing the number of travelers) generated outside the operating system of the host. Consequently, the quality of each subway station can be managed in a unified dynamic pattern. This does not only achieve the objective of patternize information, but also allows the travelers to learn about the management quality of each station.

What is claimed is:

1. A virtual dynamic pattern rendering system that changes its status according to external information, the system having a host with input devices, a display electrically coupled to the host, and an external information extracting unit, and being built in with a virtual dynamic pattern rendering method comprising steps of:
building in with an initial dynamic pattern having a plurality of internal dynamic parameters and a plurality of external dynamic parameters;
determining features of the dynamic pattern, the features including external features and internal features;
associating the internal dynamic parameters with the corresponding features of the pattern, the internal dynamic parameters being determined by the user;
associating the external dynamic parameters with the corresponding features of the pattern, the external dynamic parameters being determined by an independent external signal that enters the host;
displaying the initial pattern on the display;
receiving the internal and external dynamic parameters and determining whether any of them is changed, and changing the corresponding feature if any of them is changed; and
changing the initial dynamic pattern according to the changes in the features, so that the changed pattern reflects the changes in the internal or external dynamic parameters.

2. The virtual dynamic pattern rendering system of claim 1, wherein the initial dynamic pattern further comprises initial parameters and a time parameter used to determine the pattern size.

3. The virtual dynamic pattern rendering system of claim 1, wherein the step of associating the external dynamic parameters with the corresponding features of the pattern puts different weights on the external dynamic parameters.

4. The virtual dynamic pattern rendering system of claim 2, wherein the step of associating the external dynamic parameters with the corresponding features of the pattern puts different weights on the external dynamic parameters.

5. The virtual dynamic pattern rendering system of claim 2, wherein the step of associating the external dynamic parameters with the corresponding features of the pattern puts different weights on the external dynamic parameters.

6. The virtual dynamic pattern rendering system of claim 1, wherein the host controls the display and includes:
a dynamic pattern display area;
an external feature area;
an internal feature area;
an external dynamic parameter area; and
an internal dynamic parameter area, which has function buttons on the input devices corresponding to the internal dynamic parameters.

7. The virtual dynamic pattern rendering system of claim 1, wherein the internal features of the virtual dynamic pattern include name, size, species, birthday, age, and gender, and the internal features include learning ability, character, physical strength, wisdom, charm, martial arts, and friendship.

8. The virtual dynamic pattern rendering system of claim 1, wherein the independent external signal is a wireless communication signal, an Internet signal, or an electronic signal produced by the operating system of any other host.

9. The virtual dynamic pattern rendering system of claim 6, wherein the independent external signal is a wireless communication signal, an Internet signal, or an electronic signal produced by the operating system of any other host.

10. The virtual dynamic pattern rendering system of claim 8, wherein the electronic signal comprises the number of incoming calls, the number of dialed calls, the number of received messages, the number of sent messages, the type of ring, and the connection method.

11. The virtual dynamic pattern rendering system of claim 9, wherein the electronic signal comprises the number of incoming calls, the number of dialed calls, the number of received messages, the number of sent messages, the type of ring, and the connection method.

12. The virtual dynamic pattern rendering system of claim 8, wherein the electronic signal comprises the number of received/sent E-mail messages, the number of network connections, the number of multimedia been played, the number of virus attacks, and the network connection method.

13. The virtual dynamic pattern rendering system of claim 9, wherein the electronic signal comprises the number of received/sent E-mail messages, the number of network connections, the number of multimedia been played, the number of virus attacks, and the network connection method.
